(19) United States
(12) Patent Application Publication
(10) Pub. No.: US 2012/0173488 A1
(43) Pub. Date: Jul. 5, 2012

(54) TENANT-SEPARATED DATA STORAGE FOR LIFECYCLE MANAGEMENT IN A MULTI-TENANCY ENVIRONMENT

(76) Inventors: Lars Spielberg, St. Leon-Rot (DE); Michael Pohlmann, Heidelberg (DE)

(21) Appl. No.: 12/981,366

(22) Filed: Dec. 29, 2010

(51) Int. Cl. G06F 7/00; G06F 17/30

(52) U.S. Cl. 707/639; 707/812; 707/640; 707/E17.005; 707/E17.01

(57) ABSTRACT

A system, method and computer program product for tenant separated data storage for lifecycle management in a multi-tenancy environment is presented. A plurality of data containers is defined in a storage subsystem, each data container comprising a main data storage and a file system data storage for receiving, respectively, main data and file system data, each of the plurality of data containers being separate from all other data containers of the plurality of data containers. For each tenant of a plurality of tenants of a multi-tenancy computing system, main data is stored in the main data storage of one of the plurality of data containers and storing file system data in the file system data storage of the one of the plurality of data containers. For a transaction to be executed with a source tenant, only main data and file system data is accessed from a data container associated with the source tenant. The transaction is executed with the main data and file system data accessed from the data container associated with the source tenant.

### BACKGROUND

This disclosure relates generally to multi-tenant computing environments, and more particularly to tenant-separated data storage for lifecycle management in a multi-tenant environment.

Modern information technology business is increasingly demanding on its infrastructure. Not only is the complexity of today's enterprise computing landscapes constantly increasing, but the needs to reduce costs of running IT-businesses is also evident. To address these infrastructure and cost issues, companies like SAP AG of Walldorf, Germany are developing new on-demand computing infrastructures. SAP, for example, has created a platform known as “Business ByDesign™” (ByD), an on-demand software platform for small and midsize customers that will help to reduce IT costs for the customers.

One of the key features in an on-demand software platform such as ByD is “multi-tenancy”, which means that a single system is shared among various entities called “tenants” or “clients”. Each tenant represents a separate customer and runs in its own isolated environment separated from other tenants, while still sharing the same runtime environment of the system, such as the Advanced Business Application Programming (ABAP) runtime of the SAP ByD system. One major consideration in operating such a multi-tenant landscape is the tenant lifecycle management, e.g. processes for the creation of a new tenant, or movement of a tenant from one system to another. These processes need to be efficient to reduce the costs of the overall solution.

As depicted in FIG. 1, tenant data generally consists of two different kinds of persistence: main data of a tenant is stored in a database of the system (primary persistence); and search engine data is stored in a file system of application servers of the system (secondary persistence). Copying a tenant's data therefore requires different techniques: data in the database is copied using so-called remote function call (RFC) techniques between two ABAP-runtime engines, whereas the search engine data is copied via the network using operating system techniques such as remote copy protocol (RCP) or secure copy protocol (SCP). Both techniques rely on data movement via a network, which can be slow and lead to a long downtime for the source tenant. During the entire tenant copy process, which can last for several hours or more, the source tenant must be offline to ensure a consistent data copy. Moreover the new tenant is only available once the entire data is copied, meaning several more hours after the tenant copy process was started. Thus a tenant copy process is very time-consuming and expensive.

### SUMMARY

In general, this document discloses a system and method for tenant separated data storage for lifecycle management in a multi-tenancy environment.

In one aspect, a computer-implemented method includes defining a plurality of data containers in a storage subsystem. Each data container includes a main data storage and a file system data storage for receiving, respectively, main data and file system data, each of the plurality of data containers being separate from all other data containers of the plurality of data containers. The method further includes, for each tenant of a plurality of tenants of a multi-tenancy computing system, storing main data in the main data storage of one of the plurality of data containers and storing file system data in the file system data storage of the one of the plurality of data containers, and for a transaction to be executed with a source tenant, accessing only main data and file system data from a data container associated with the source tenant. The method further includes executing the transaction with the main data and file system data accessed from the data container associated with the source tenant.

In another aspect, a system includes a plurality of data containers defined in a storage subsystem. Each data container includes a main data storage and a file system data storage for receiving, respectively, main data and file system data, each of the plurality of data containers being separate from all other data containers of the plurality of data containers. The system further includes a plurality of tenants of a multi-tenancy computing system, each tenant storing main data in the main data storage of one of the plurality of data containers and storing file system data in the file system data storage of the one of the plurality of data containers, where only main data and file system data from a data container associated with the source tenant is accessed for a transaction to be executed with a source tenant. The system further includes one or more processors for executing the transaction with the main data and file system data accessed from the data container associated with the source tenant.

In yet another aspect, a computer program product includes a non-transitory storage medium readable by at least one processor and storing instructions for execution by the at least one processor, including instructions for defining a plurality of data containers in a storage subsystem. Each data container includes a main data storage and a file system data storage for receiving, respectively, main data and file system data, each of the plurality of data containers being separate from all other data containers of the plurality of data containers. The computer program product further includes instructions, for each tenant of a plurality of tenants of a multi-tenancy computing system, for storing main data in the main data storage of one of the plurality of data containers and storing file system data in the file system data storage of the one of the plurality of data containers, and for connecting a plurality of storage subsystems together to form a virtual storage between a plurality of multi-tenant computing systems. The computer program product further includes instructions, for a transaction to be executed with a source tenant, for accessing only main data and file system data from a data container associated with the source tenant, and for executing, via the virtual storage, the transaction with the main data and file system data accessed from the data container associated with the source tenant.

With the implementation of the system and method as set forth herein, tenant copy processes will speed up dramatically. The overall duration for a tenant copy and downtime of the involved source and target tenants can be measured in minutes compared to approx 3-4 hours with conventional process. Moreover the absence of a physical data transport and data duplication in case of a non-split clone operation reduces the costs of information technology operations in using storage space more efficiently. This immense acceleration and data volume reduction will have a massive impact on the overall costs of the Tenant Lifecycle Management (TLM) reducing the TCO significantly.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 depicts an on-demand software platform having heterogeneous data persistence.

FIG. 2 is a block diagram of a multi-tenant computing system having a homogenous storage for each tenant.

FIG. 3 illustrates a multi-tenant computing system, in which a number of storage subsystems can be connected together to form a virtual storage.

FIGS. 4-8 illustrate various processes of lifecycle management in a multi-tenancy environment.

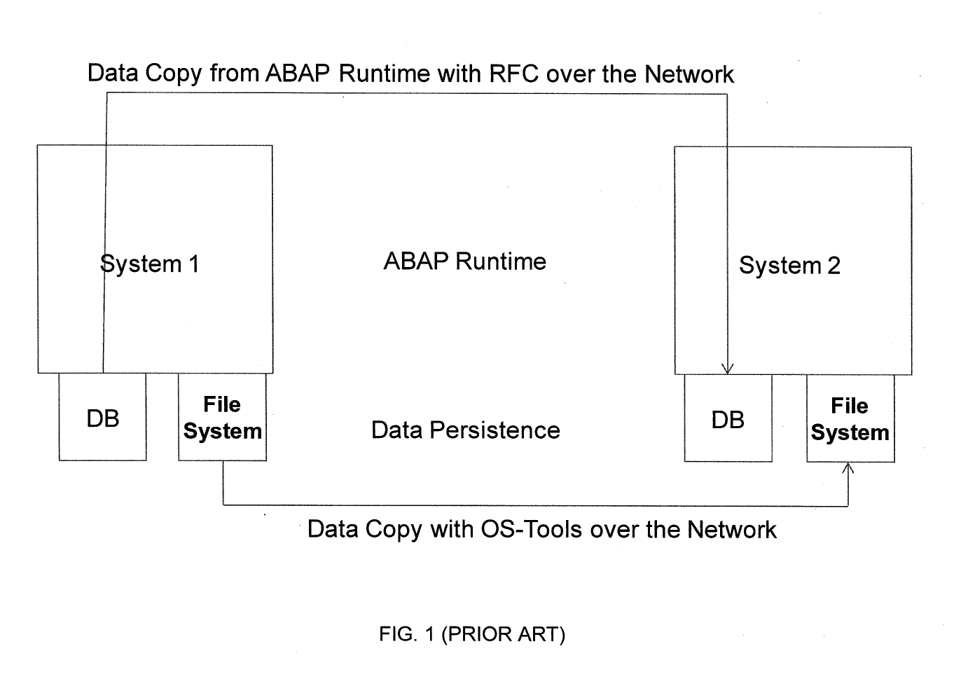

Like reference symbols in the various drawings indicate like elements.

### DETAILED DESCRIPTION

This document describes a system and method for tenant-separated data storage for lifecycle management in a multi-tenancy environment. The system and method enables replacement of heterogeneous data persistence with a homogenous data persistence on a storage subsystem, where each tenant's data is stored separately from other tenants' data, and can be handled and copied with modern storage infrastructure techniques such as “snapshots” and “clones.”

A database provides data separation, which allows physical separation of one part of the tenants' data (i.e. data that is being persisted in the database) from each other tenant's data, to be accessible on an OS-level. Accordingly, each tenant's data is stored homogenously in its own data container, separated from other tenants' data containers on the storage subsystem and handled and copied very easily and quickly with modern storage techniques. In accordance with implementations described herein, downtime of the source tenant during a copy process is reduced from several hours to only a matter of minutes. The source tenant can then be started again and the customer can continue working in the tenant.

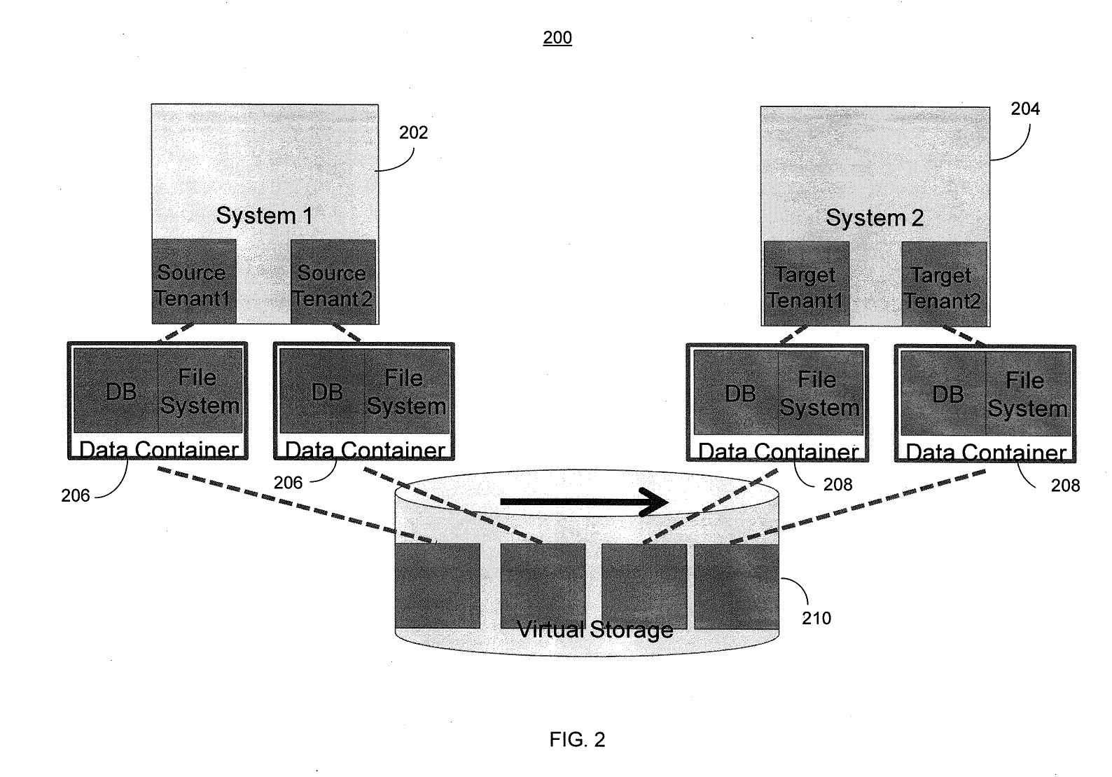

In some implementations, a snapshot and/or cloning process is used, as illustrated in FIG. 2, which shows a system 200 for copying tenant data from a first system 202 to a second system 204. The snapshot is a consistent point-in-time image of the tenant's data. Based on the snapshot, a clone of the source tenant can be created in a background storage subsystem, called a data container 206 without affecting the running source tenant. The clone will become the target tenant of the source tenant based on a target tenant data container 208. If the newly created target tenant clone is created without a split of the source and target data containers 206, 208, no physical data transport is even necessary.

The new target tenant writes all of its changes to its own new data container 208 but will point to the source tenant's data container 206 for reading old data. This helps to limit the amount of data that is being generated, thus helping to use storage space more efficiently. But if the data containers are split, i.e. for security reasons, the system 200 can copy data in the background very fast, faster than copying data over the network. So, a new target tenant based on a clone of the source tenant will be available dramatically faster than if generated using current procedures.

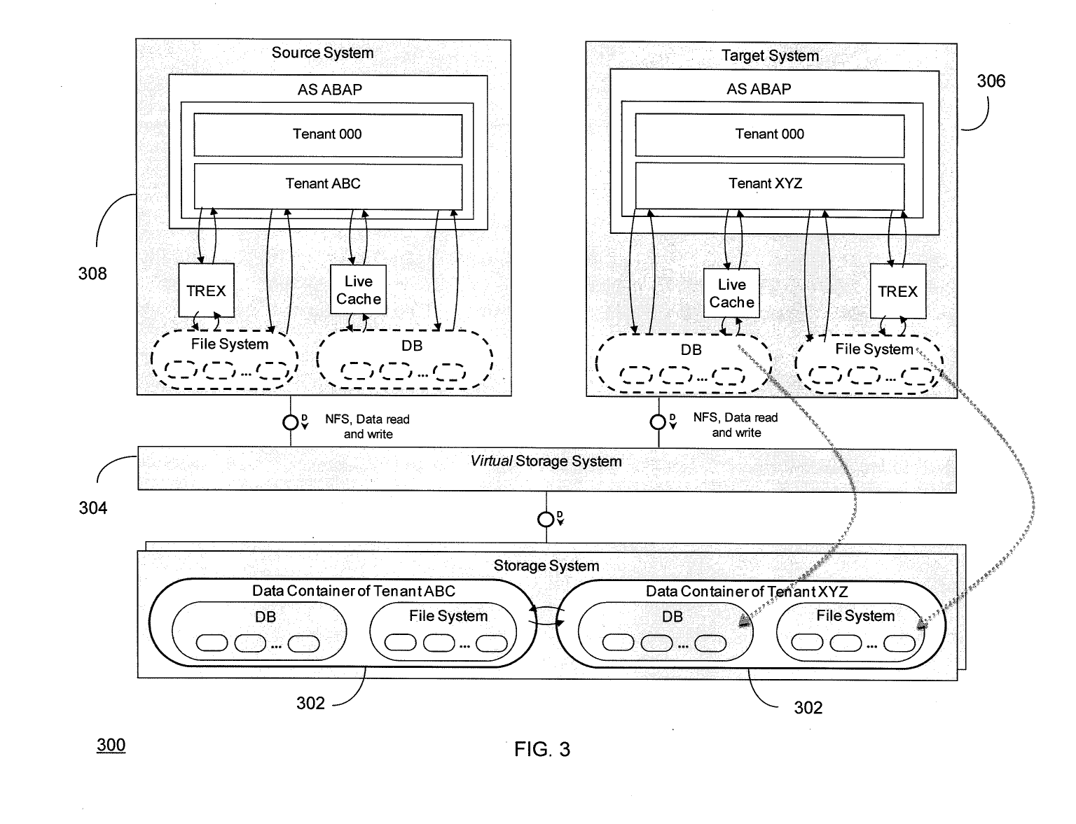

FIG. 3 illustrates a multi-tenant computing system 300, in which a number of storage subsystems 302 can be connected together to form a virtual storage 304. The virtual storage 304 does not limit data copy to one storage subsystem of a target system 306 from a source system 308, but allows data copy to be done throughout a connected virtualized storage layer that can be extended with additional storage subsystems 302 if necessary. Accordingly, this solution can be scaled based on the number of tenants in a computing landscape, and can also be easily adjusted according to the needs of an on-demand scenario such as e.g. SAP ByD, reducing system downtimes and total costs of ownership (TCO).

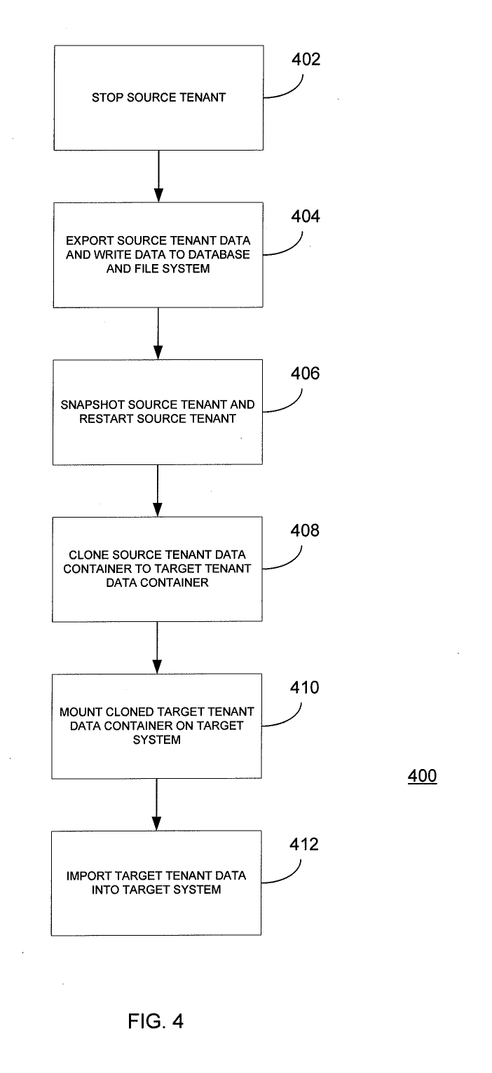

FIGS. 4-8 illustrate various processes of lifecycle management in a multi-tenancy environment. In particular, FIGS. 4-8 illustrate operations to copy, move, backup, restore, split and delete a tenant in a multi-tenancy environment, using tenant-separated data storage as described above.

FIG. 4 illustrates a method 400 to copy a tenant, either on the same system or from one system to another system. At 402, a source tenant is stopped. The source tenant represents all of the functionality and business applications being performed on main data and search engine data of the source tenant on a multi-tenant computing system. At 404, source tenant data is exported to a new system or a different tenancy of the same system, and main data and search engine data is written to a database and a file system, respectively, in a tenant data container of a virtual storage system. At 406, a snapshot is taken of the source tenant data, and the source tenant is restarted.

At 408, the source tenant data is cloned to a target tenant data container of the virtual storage system. At 410, the cloned target tenant data container is mounted on a target system, i.e. either the new system or the different tenancy of the same system. At 412, the target tenant data is imported into the target system, i.e. as a registration of a “new” tenant.

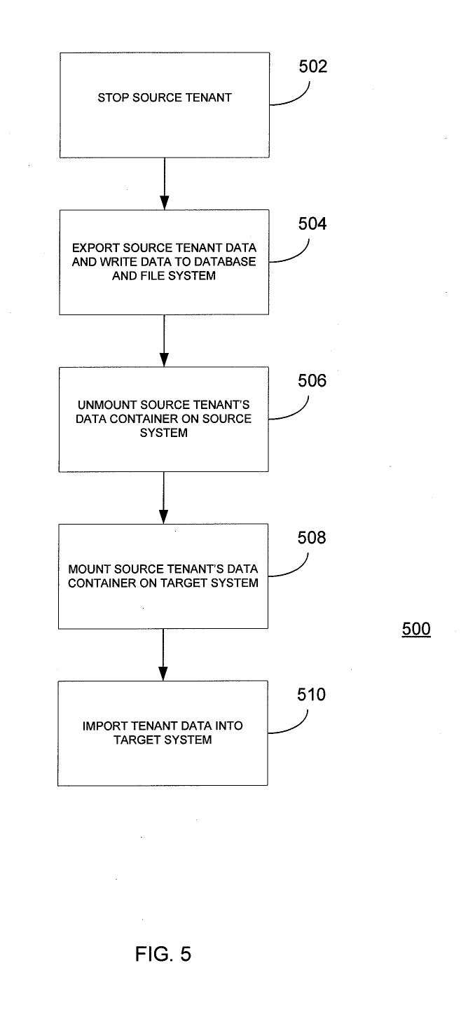

FIG. 5 illustrates a method 500 to copy a tenant to another system. At 402, a source tenant is stopped. The source tenant represents all of the functionality and business applications being performed on main data and search engine data of the source tenant on a multi-tenant computing system. At 504, source tenant data is exported to a new system, and main data and search engine data is written to a database and a file system, respectively, in a tenant data container of a virtual storage system. At 506, the source tenant's data container on the source system is unmounted. At 508, the source tenant's data container is mounted on a target system, and at 510 the source tenant data is imported into the target system.

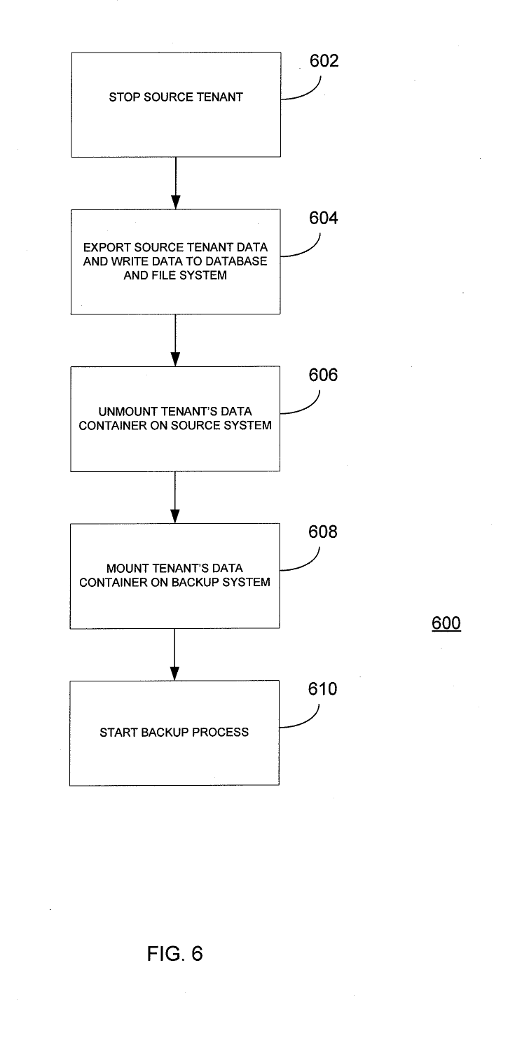

FIG. 6 illustrates a method 600 to backup a tenant, either on the same system or on another system, referred to herein as a backup system. At 602, a source tenant is stopped. The source tenant represents all of the functionality and business applications being performed on main data and search engine data of the source tenant on a multi-tenant computing system. At 604, source tenant data is exported to a new system or a different tenancy of the same system, and main data and search engine data is written to a database and a file system, respectively, in a tenant data container of a virtual storage system. At 606, the tenant's data container is unmounted from the source system, and at 608 the tenant's data container is mounted on the backup system. At 610, the appropriate backup process(es) on the backup system are started.

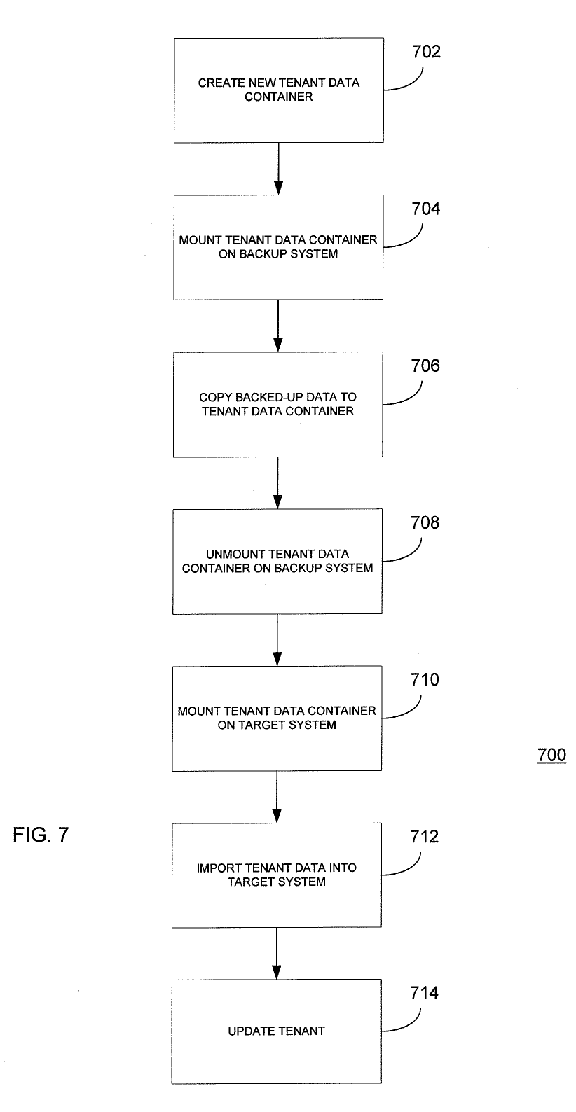

FIG. 7 illustrates a method 700 to restore a tenant from a source system to a target system. At 702 a new tenant data container is created, in a virtual storage system. At 704, the tenant data container is mounted to a backup system. At 706, backed-up data is copied to the tenant data container. At 708, the tenant data container is unmounted from the backup system. At 710, the tenant data container is mounted from the virtual storage system to the target system, and at 712 tenant data is imported into the target system. At 714 the tenant is updated to complete the restoration process and method 700.

A split of a tenant is executed similarly to a copy of a tenant, i.e. of method 300. Since the copy of a tenant is based on a clone of a source tenant's data container without split, the loss of the source tenant's data container will result in a loss of the target tenant. Therefore, for safety it is preferable to split the target tenant's data container from the source tenant's data container to ensure independence of both tenants' data. This splitting process can run in parallel in the background of a copy method.

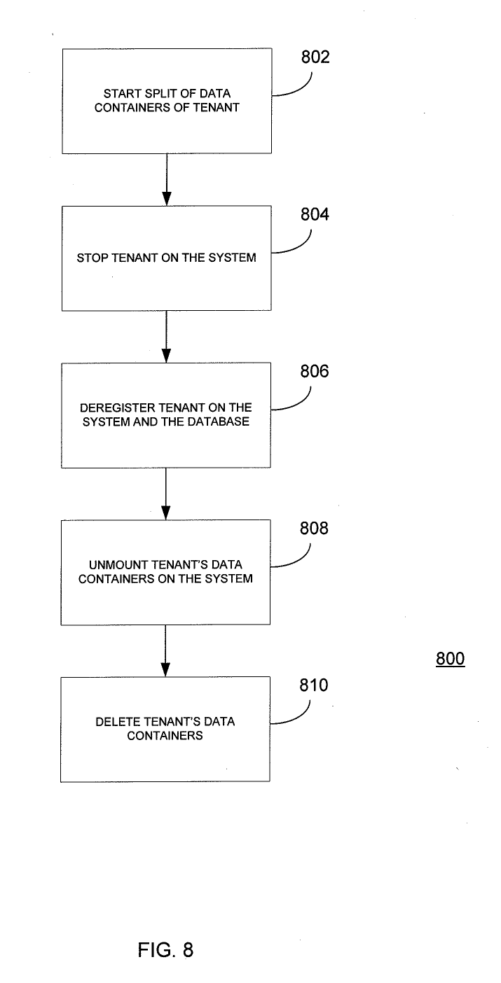

FIG. 8 illustrates a method 800 to delete a tenant, which is based at least partially on a split of a tenant as described above. At 802, a split of the data containers of the tenant is started, and at 804 the tenant is stopped on the system, and at 806 the tenant is deregistered from the system and the database. At 808, the tenant's data containers are unmounted from the system, and at 810 the tenant's data containers are deleted to complete the method 800.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by; and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A computer-implemented method comprising:
defining a plurality of data containers in a storage subsystem, each data container comprising a main data storage and a file system data storage for receiving, respectively, main data and file system data, each of the plurality of data containers being separate from all other data containers of the plurality of data containers;
for each tenant of a plurality of tenants of a multi-tenancy computing system, storing main data in the main data storage of one of the plurality of data containers and storing file system data in the file system data storage of the one of the plurality of data containers;
for a transaction to be executed with a source tenant, accessing only main data and file system data from a data container associated with the source tenant; and
executing the transaction with the main data and file system data accessed from the data container associated with the source tenant.

2. The computer-implemented method in accordance with claim 1, wherein the transaction is a copy transaction, and wherein executing the transaction includes:
stopping computing by the source tenant;
exporting the main data and file system data accessed from the data container associated with the source tenant to a data container associated with the target tenant;
generating a digital snapshot of the main data and file system data in the data container associated with the target tenant; and
restarting computing by the source tenant.

3. The computer-implemented method in accordance with claim 1, further comprising connecting a plurality of storage subsystems together to form a virtual storage between a plurality of multi-tenant computing systems.

4. The computer-implemented method in accordance with claim 3, wherein the transaction is a copy transaction from the source tenant of a first multi-tenant computing system to a target tenant of a second multi-tenant computing system of the plurality of multi-tenant computing systems, and wherein executing the transaction includes:
stopping computing by the source tenant;
exporting, via the virtual storage, the main data and file system data accessed from the data container associated with the source tenant to a data container associated with the target tenant;
generating a digital snapshot of the main data and file system data in the data container associated with the target tenant; and
restarting computing by the source tenant.

5. The computer-implemented method in accordance with claim 3, wherein the transaction is a backup transaction to backup the source tenant on a backup multi-tenant computing system, and wherein executing the transaction includes:
stopping computing by the source tenant;
exporting, via the virtual storage, the main data and file system data accessed from the data container associated with the source tenant to a second data container associated with the source tenant;
unmounting the second data container from a source multi-tenant computing system; and
mounting the second data container to the backup multi-tenant computing system.

6. The computer-implemented method in accordance with claim 5, wherein the transaction is a restore transaction to restore the source tenant from the source multi-tenant computing system to a target multi-tenant system, and wherein executing the transaction includes:
creating a new data container in the virtual storage;
mounting the data container associated with the source tenant to the backup multi-tenant computing system;
copying the main data and file system data accessed from the data container associated with the source tenant to the new data container; and
restoring the source tenant with the new data container.

7. The computer-implemented method in accordance with claim 1, wherein the main data includes database data, and wherein file system data includes search engine data.

8. A system comprising:
a plurality of data containers defined in a storage subsystem, each data container comprising a main data storage and a file system data storage for receiving, respectively, main data and file system data, each of the plurality of data containers being separate from all other data containers of the plurality of data containers;
a plurality of tenants of a multi-tenancy computing system, each tenant storing main data in the main data storage of one of the plurality of data containers and storing file system data in the file system data storage of the one of the plurality of data containers, only main data and file system data from a data container associated with the source tenant being accessed for a transaction to be executed with a source tenant; and
one or more processors for executing the transaction with the main data and file system data accessed from the data container associated with the source tenant.

9. The system in accordance with claim 8, wherein the transaction is a copy transaction, and wherein executing the transaction includes:
stopping, using the one or more processors, computing by the source tenant;
exporting, using the one or more processors, the main data and file system data accessed from the data container associated with the source tenant to a data container associated with the target tenant;
generating, using the one or more processors, a digital snapshot of the main data and file system data in the data container associated with the target tenant; and
restarting, using the one or more processors, computing by the source tenant.

10. The system in accordance with claim 8, further comprising connecting a plurality of storage subsystems together to form a virtual storage between a plurality of multi-tenant computing systems.

11. The system in accordance with claim 10, wherein the transaction is a copy transaction from the source tenant of a first multi-tenant computing system to a target tenant of a second multi-tenant computing system of the plurality of multi-tenant computing systems, and wherein executing the transaction includes:
stopping, using the one or more processors, computing by the source tenant;
exporting, via the virtual storage and using the one or more processors, the main data and file system data accessed from the data container associated with the source tenant to a data container associated with the target tenant;
generating, using the one or more processors, a digital snapshot of the main data and file system data in the data container associated with the target tenant; and
restarting, using the one or more processors, computing by the source tenant.

12. The system in accordance with claim 10, wherein the transaction is a backup transaction to backup the source tenant on a backup multi-tenant computing system, and wherein executing the transaction includes the one or more processors:
stopping computing by the source tenant;
exporting, via the virtual storage, the main data and file system data accessed from the data container associated with the source tenant to a second data container associated with the source tenant;
unmounting the second data container from a source multi-tenant computing system; and
mounting the second data container to the backup multi-tenant computing system.

13. The system in accordance with claim 12, wherein the transaction is a restore transaction to restore the source tenant from the source multi-tenant computing system to a target multi-tenant system, and wherein executing the transaction includes the one or more processors:
creating a new data container in the virtual storage;
mounting the data container associated with the source tenant to the backup multi-tenant computing system;
copying the main data and file system data accessed from the data container associated with the source tenant to the new data container; and
restoring the source tenant with the new data container.

14. The system in accordance with claim 8, wherein the main data includes database data, and wherein file system data includes search engine data.

15. A computer program product comprising a non-transitory storage medium readable by at least one processor and storing instructions for execution by the at least one processor for:
defining a plurality of data containers in a storage subsystem, each data container comprising a main data storage and a file system data storage for receiving, respectively, main data and file system data, each of the plurality of data containers being separate from all other data containers of the plurality of data containers;
for each tenant of a plurality of tenants of a multi-tenancy computing system, storing main data in the main data storage of one of the plurality of data containers and storing file system data in the file system data storage of the one of the plurality of data containers;
connecting a plurality of storage subsystems together to form a virtual storage between a plurality of multi-tenant computing systems;
for a transaction to be executed with a source tenant, accessing only main data and file system data from a data container associated with the source tenant; and
executing, via the virtual storage, the transaction with the main data and file system data accessed from the data container associated with the source tenant.

16. The computer program product in accordance with claim 15, wherein the transaction is a copy transaction, and wherein executing the transaction includes, by the at least one processor:
stopping computing by the source tenant;
exporting the main data and file system data accessed from the data container associated with the source tenant to a data container associated with the target tenant;
generating a digital snapshot of the main data and file system data in the data container associated with the target tenant; and
restarting computing by the source tenant.

17. The computer program product in accordance with claim 15, wherein the transaction is a copy transaction from the source tenant of a first multi-tenant computing system to a target tenant of a second multi-tenant computing system of the plurality of multi-tenant computing systems, and wherein executing the transaction includes by the at least one processor:
stopping computing by the source tenant;
exporting, via the virtual storage, the main data and file system data accessed from the data container associated with the source tenant to a data container associated with the target tenant;
generating a digital snapshot of the main data and file system data in the data container associated with the target tenant; and
restarting computing by the source tenant.

18. The computer-implemented method in accordance with claim 15, wherein the transaction is a backup transaction to backup the source tenant on a backup multi-tenant computing system, and wherein executing the transaction includes by the at least one processor:
stopping computing by the source tenant;
exporting, via the virtual storage, the main data and file system data accessed from the data container associated with the source tenant to a second data container associated with the source tenant;
unmounting the second data container from a source multi-tenant computing system; and
mounting the second data container to the backup multi-tenant computing system.

19. The computer-implemented method in accordance with claim 18, wherein the transaction is a restore transaction to restore the source tenant from the source multi-tenant computing system to a target multi-tenant system, and wherein executing the transaction includes by the at least one processor:
creating a new data container in the virtual storage;
mounting the data container associated with the source tenant to the backup multi-tenant computing system;
copying the main data and file system data accessed from the data container associated with the source tenant to the new data container; and
restoring the source tenant with the new data container.

20. The computer-implemented method in accordance with claim 15, wherein the main data includes database data, and wherein file system data includes search engine data.
